(19) United States
(12) Patent Application Publication
(10) Pub. No.: US 2005/0253832 A1
(43) Pub. Date: Nov. 17, 2005

(54) Display device capable of detecting battery removal and a method of removing a latent image

(75) Inventor: Kyu-Young Chung, Seoul (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/128,031

(22) Filed: May 12, 2005

(30) Foreign Application Priority Data
May 13, 2004 (KR) 2004-33803

(51) Int. Cl. G09G 5/00

(52) U.S. Cl. 345/204

(57) ABSTRACT

Provided is a display device capable of detecting battery removal and a method of removing a latent image from a panel. The display device includes a panel, and a driver unit displaying an image on the panel, wherein the driver unit comprises: a controller, generating a control signal and color data in response to a first power supply voltage; a voltage generator, generating control voltages in response to the control signal and a second power supply voltage; a voltage level controller, receiving the control voltages, outputting the control voltages in a first operation mode, and outputting the control voltages as first-level voltages in a second operation mode; and a source driver and a gate driver, controlling source lines and gate lines of the panel, respectively, in response to the color data, the control signal, and the control voltages. The first operation mode indicates that the display device is operating normally and the second operation mode indicates that the battery has been removed from the display panel.

### CROSS-REFERENCE TO RELATED APPLICATION

This application claims priority to Korean Patent Application No. 10-2004-0033803, filed on May 13, 2004, in the Korean Intellectual Property Office, the disclosure of which is incorporated herein by reference in its entirety.

### FIELD OF THE INVENTION

The present invention relates to a display device capable of detecting battery removal and a method of removing a latent image therefrom, and more particularly, to a display device and method for immediately removing a latent image from a panel of the display device.

### DESCRIPTION OF THE RELATED ART

When a battery for generating a power supply voltage is removed from a display device such as a Thin Film Transistor-Liquid Crystal Display (TFT-LCD), a latent image remains in a liquid crystal panel for a predetermined time and gradually disappears.

FIG. 1 is a circuit diagram of a conventional display device 100. The display device 100 of FIG. 1 includes a panel 110, and a driver unit 120 that drives the panel 110. The driver unit 120 includes a controller 130, a voltage generator 140, a gate driver 150, and a source driver 160.

The panel 110 includes a plurality of transistors TFT and a plurality of capacitors CST that store color data DATA. A pixel is generated by each of the transistors TFT and each of the capacitors CST. Referring to FIG. 1, CL denotes a model of the parasitic capacitance of the liquid crystal of a pixel.

A controller 130 generates the color data DATA that is to be displayed on the panel 100 and a control signal CTRLS in response to a first power supply voltage VDD being applied. A voltage generator 140 generates control voltages AVDD, GVDD, VCOMH, VCOML, VGH, and VGOFF in response to a second power supply voltage VCI being applied. The control voltages AVDD, GVDD, VCOMH, VCOML, VGH, and VGOFF control the operations of the panel 110, the gate driver 150, and the source driver 160.

Specifically, the control voltages VGH and VGOFF are first and second drive voltages being applied to the gate driver 150, the control voltages AVDD and GVDD are first and second source drive voltages being applied to the source driver 160, and the control voltages VCOMH and VCOML are first and second common voltages being applied to the panel 110.

The control voltages AVDD, GVDD, VCOMH, VCOML, VGH, and VGOFF are generated by increasing or reducing the second power supply voltage VCI. The gate driver 150 controls gate lines of the panel 110. The source driver 160 controls the source lines of the panel 110 and applies the color data DATA to the panel 110.

The first and second power supply voltages VDD and VCI are output from a battery (not shown) of the display device 100.

However, if the battery is unexpectedly removed from the display device 100 during operation, the first and second power supply voltages VDD and VCI gradually become 0V. In this case, the operation of the controller 130 and generation of the control signal CTRLS are discontinued, and the state of the color data DATA displayed immediately before the removal of the battery is maintained.

Also, the second gate drive voltage VGOFF is maintained at all the gate lines of the panel 110 except those selected immediately before the removal of the battery. The first gate drive voltage VGH is maintained at the gate lines selected immediately before the removal of the battery.

The capacitors CST of the panel 110 store the color data DATA displayed immediately before the battery removal. In other words, when the battery is unexpectedly removed from the display device 100, the color data DATA displayed immediately before the battery removal is stored in the panel 110.

However, since all the gate lines of the panel 110, except those selected immediately before the battery removal, are deactivated, there is no path through which the color data DATA stored in the panel 110 is discharged to the outside of the display device 100. As a result, a latent image is displayed in the panel 110 until the color data DATA is naturally discharged.

Accordingly, there is a need for an apparatus and method for immediately removing an afterimage from a panel upon loss of power or removal of the battery.

### SUMMARY OF THE INVENTION

According to one aspect of the present invention, there is provided a display device comprising a panel, and a driver unit displaying an image on the panel. The driver unit comprises a controller generating a control signal and color data in response to a first power supply voltage; a voltage generator generating control voltages in response to the control signal and a second power supply voltage; a voltage level controller receiving the control voltages, outputting the control voltages in a first operation mode, and outputting the control voltages as first-level voltages in a second operation mode; and a source driver and a gate driver controlling source lines and gate lines of the panel, respectively, in response to the color data, the control signal, and the control voltages.

The gate driver equalizes voltages at all the gate lines of the panel with the first-level voltage in response to parts of the control voltages in the second operation mode, and the source driver equalizes voltages output from output terminals of all the source lines of the panel with the first-level voltage in response to other parts of the control voltages in the second operation mode.

In the first operation mode, the display device operates normally, and in the second operation mode, a battery is removed from the display device.

The first and second power supply voltages are output from the battery in the first operation mode and are equalized with a ground voltage in the second operation mode. The second power supply voltage is larger than the first power supply voltage in the first operation mode.

The control voltages comprise: a first gate drive voltage and a second gate drive voltage, applied to the gate driver; a first source drive voltage and a second source drive voltage, applied to the source driver; and a first common voltage and a second common voltage, applied to the panel.

The voltage level controller comprises: a positive discharge circuit, equalizing positive control voltages of the control voltages that have positive voltage levels with the first-level voltage in the second operation mode; and a negative discharge circuit, equalizing negative control voltages of the control voltages that have negative voltage levels with the first-level voltage in the second operation mode.

The positive discharge circuit comprises positive dischargers connected to the positive control voltages, respectively. Each of the positive dischargers comprises a first bias circuit being turned off in the first operation mode, and generating a first bias current in response to one of the first and second power supply voltages in the second operation mode; and a first controller being turned off in the first operation mode, and equalizing the first gate drive voltage, the first source drive voltage, and the first common voltage with the first-level voltage in response to the first bias current in the second operation mode.

The first bias circuit includes first through seventh positive bias transistors and a first capacitor. The first controller includes first through third positive transistors.

A first terminal and gate of the first positive bias transistor are connected to the positive control voltage and a gate of the sixth bias transistor, respectively. A first terminal, gate, and second terminal of the second positive bias transistor are connected to the second terminal of the first positive bias transistor, one of the first and second power supply voltages, and the ground voltage, respectively.

A first terminal, gate, and second terminal of the third bias transistor are connected to the positive control voltage, the second terminal of the first positive bias transistor, and the ground voltage, respectively.

The negative discharge circuit comprises negative dischargers connected to the negative control voltages, respectively. Each of the negative dischargers comprises a second bias circuit being turned off in the first operation mode, and generating a second bias current in response to one of the first and second power supply voltages in the second operation mode; and a second controller being turned off in the first operation mode, and equalizing the second gate drive voltage, the second source drive voltage, and the second common voltage with the first-level voltage in response to the second bias current in the second operation mode.

The second bias circuit includes first through ninth negative bias transistors and a second capacitor. The first or second power supply voltage is applied to bulks of the first, second, and eighth negative bias transistor.

The bias voltage is output from the gate of the sixth positive bias transistor of the first bias circuit. The second controller includes first through third negative transistors.

The first or second power supply voltage is applied to a first terminal of the first negative transistor and the ground voltage is applied to a gate thereof. A first terminal, gate, and second terminal of the second negative transistor are connected to the second terminal of the first negative transistor, the gate of the ninth negative bias transistor, and the negative control voltage, respectively.

A first terminal, gate, and second terminal of the third negative transistor are connected to the ground voltage, the second terminal of the first negative transistor, and the negative control voltage, respectively. The panel is an active matrix type panel. The first-level voltage is the ground voltage.

According to another aspect of the present invention, there is provided a method of removing a latent image from a panel when a battery is removed from a display device with a driver unit that displays an image on the panel using control voltages, the method comprising determining whether a current mode is a first operation mode or a second operation mode; equalizing the control voltages with a first-level voltage in the second operation mode; and discharging electric charges charged in the panel in response to the control voltages that are equivalent to the first-level voltages.

The equalizing of the control voltages with the first-level voltage comprises equalizing positive control voltages of the control voltages that have positive voltage levels with the first-level voltage and equalizing negative control voltages of the control voltages that have negative voltage levels with the first-level voltage.

The discharging of electric charges comprises turning on all gate lines of the panel in response to parts of the control voltages; equalizing voltages output from output terminals of all source lines of the panel with the first-level voltage in response to other parts of the control voltages; and equalizing voltages at common voltage terminals connected to capacitors installed in the panel with the first-level voltage in response to other parts of the control voltages.

### BRIEF DESCRIPTION OF THE DRAWINGS

The above and other aspects of the present invention will become more apparent by describing in detail exemplary embodiments thereof with reference to the attached drawings in which:

FIG. 1 is a circuit diagram of a conventional display device;

FIG. 2 is a circuit diagram of a display device according to an embodiment of the present invention;

FIG. 3 is a block diagram of a voltage level controller of FIG. 2;

FIG. 4 is a circuit diagram of a positive discharger of FIG. 3;

FIG. 5 is a circuit diagram of a negative discharger of FIG. 3;

FIG. 6 is a flowchart illustrating a method of removing a latent image remaining in a panel according to an embodiment of the present invention;

FIG. 7 is a flowchart of operation 620 of FIG. 6; and

FIG. 8 is a flowchart of operation 630 of FIG. 6.

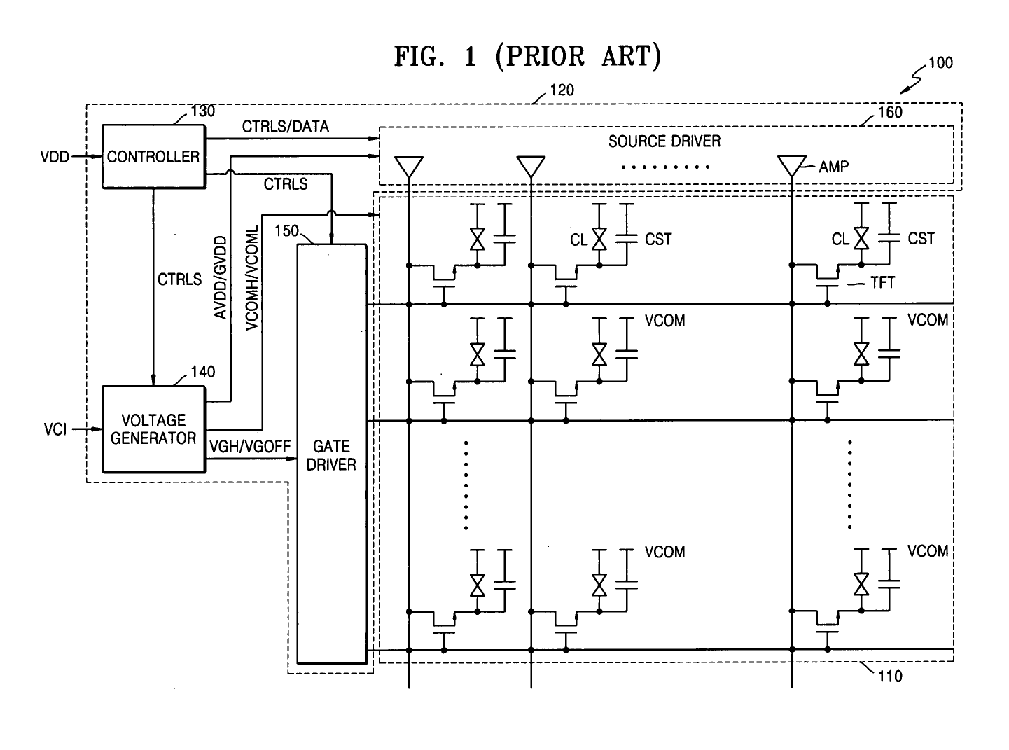

### DETAILED DESCRIPTION OF EXEMPLARY EMBODIMENTS OF THE INVENTION

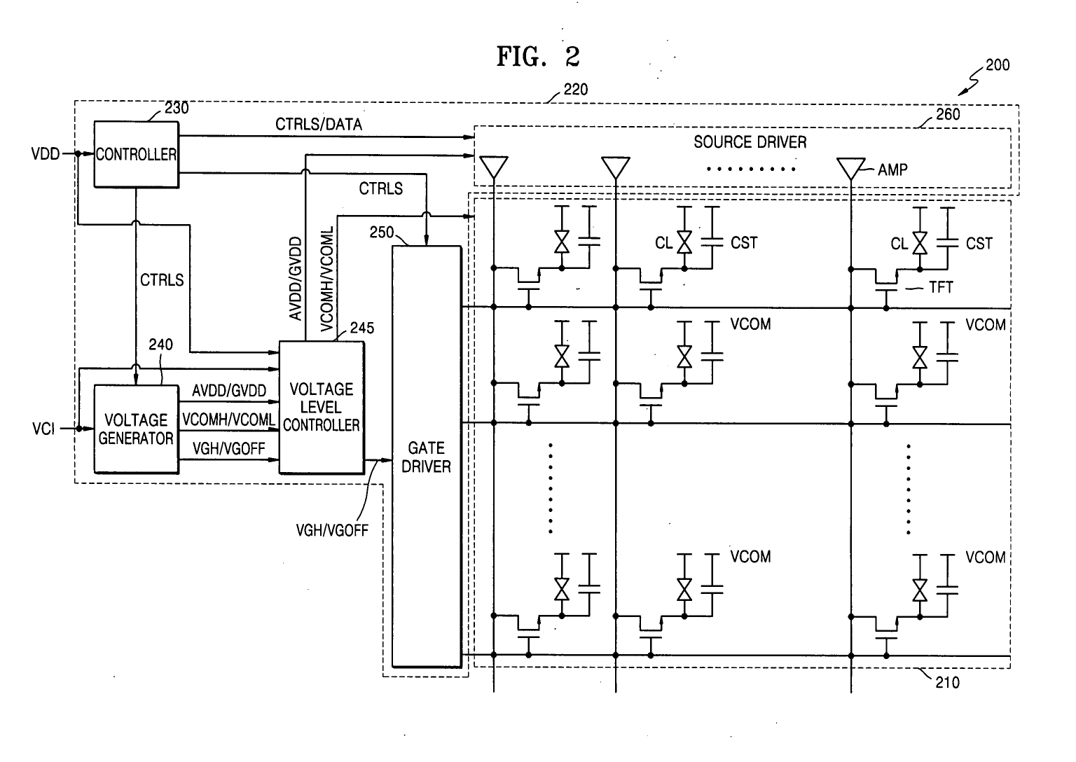

FIG. 2 is a circuit diagram of a display device 200 according to an embodiment of the present invention. The display device 200 includes a panel 210, and a driver unit 220 that displays an image on the panel 210.

The driver unit 220 includes a controller 230, a voltage generator 240, a voltage level controller 245, a gate driver 250, and a source driver 260.

The controller 230 generates a control signal CTRLS and color data DATA in response to a first power supply voltage VDD. The voltage generator 240 generates control voltages AVDD, GVDD, VCOMH, VCOML, VGH, and VGOFF in response to the control signal CTRLS and a second power supply voltage VCI. The first and second power supply voltages VDD and VCI are output from a battery (not shown). In the second operation mode, the first and second power supply voltages VDD and VCI become a ground voltage. The second power supply voltage VCI is larger than the first power supply voltage VDD in the first operation mode.

Specifically, the control voltages VGH and VGOFF are the first and second drive voltages applied to the gate driver 250, the control voltages AVDD and GVDD are the first and second source drive voltages applied to the source driver 260, and the control voltages VCOMH and VCOML are first and second common voltages applied to the panel 210.

The first gate drive voltage VGH turns on the gate lines of the panel 210 and the second gate drive voltage VGOFF turns off the gate lines of the panel 210.

The first source drive voltage AVDD drives the source driver 260, and the second source drive voltage GVDD is higher than the voltages of the color data DATA applied to the source driver 260.

The first common voltage VCOMH is a high-level voltage applied to the common voltage terminal VOCM of the panel 210, and the second common voltage VCOML is a low-level voltage applied to the common voltage terminal VCOM of the panel 210.

When the battery is removed from the display device 200 and the display device 200 enters the second operation mode, the voltage level controller 245 equalizes the control voltages AVDD, GVDD, VCOMH, VCOML, VGH, and VGOFF with the first-level voltage, i.e., the ground voltage, as described above.

When the control voltages AVDD, GVDD, VCOMH, VCOML, VGH, and VGOFF are applied to the voltage level controller 245, the voltage level controller 245 outputs these control voltages in the first operation mode, and outputs these control voltages as the first-level voltages in the second operation mode.

The source driver 260 and the gate driver 250 control the source lines and gate lines of the panel 210, in response to the color data DATA, the control signal CTRLS, and the control voltages AVDD, GVDD, VCOMH, VCOML, VGH, and VGOFF.

In the second operation mode, the gate driver 250 equalizes the voltages at all the gate lines with the first-level voltage in response to parts of the control voltages AVDD, GVDD, VCOMH, VCOML, VGH, and VGOFF. In the second operation mode, the source driver 260 equalizes the voltages at the output terminals of all the source lines of the panel 210 with the first-level voltage in response to other parts of the control voltages AVDD, GVDD, VCOMH, VCOML, VGH, and VGOFF.

In this disclosure, the first operation mode signifies when the display device 200 operates normally, and the second operation mode signifies when the power source is lost or when the battery is removed from the display device 200.

In this embodiment, when the battery is unexpectedly removed from the display device 200, the display device 200 commands a discharge circuit (not shown) to discharge the control voltages AVDD, GVDD, VCOMH, VCOML, VGH, and VGOFF generated by the driver unit 220 so as to immediately remove a latent image from the panel 210.

The second gate drive voltage VGOFF that turns off the gate lines of the panel 210 is a negative voltage. When the battery is unexpectedly removed from the display device 200, all the gate lines of the panel 210 except those selected immediately before the battery removal are turned off by the second gate drive voltage VGOFF. In this case, the color data DATA stored in capacitors CST of the panel 210 cannot be discharged to the outside of the display device 200.

In this embodiment, the discharge circuit equalizes the voltages at the gate lines with the ground voltage so that current can flow through the gate lines even if the gate lines are completely turned on.

The discharge circuit also equalizes the voltages at the source lines of the panel 210 with the ground voltage. Therefore, it is possible to rapidly discharge the color data DATA remaining in the capacitors CST of the panel 210 and remove the latent image from the panel 210.

The voltage level controller 245 acts as the discharge circuit that controls the voltages at the gates lines and the source lines of the panel 210.

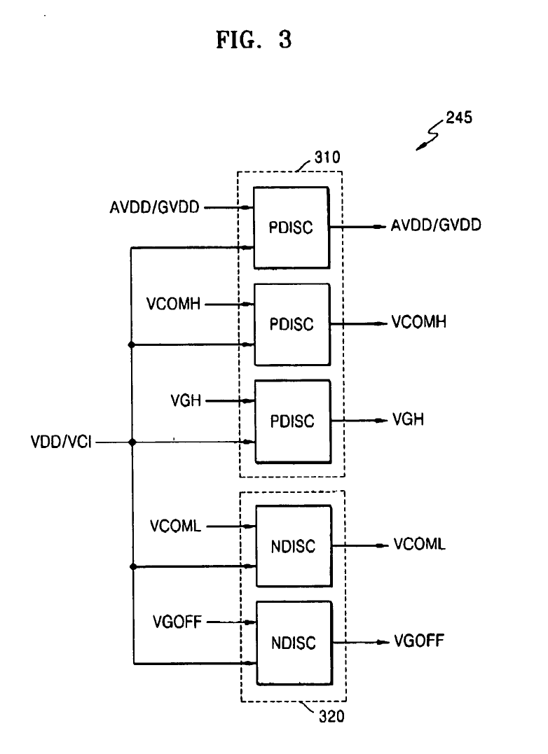

FIG. 3 is a block diagram of the voltage level controller 245 of FIG. 2. Referring to FIG. 3, the voltage level controller 245 includes a positive discharge circuit 310 and a negative discharge circuit 320.

In the second operation mode, the positive discharge circuit 310 equalizes the positive control voltages AVDD, GVDD, VCOMH, and VGH with the first-level voltage. The positive discharge circuit 310 includes positive dischargers PDISC to which the positive control voltages AVDD, GVDD, VCOMH, and VGH are applied. The first-level voltage is the ground voltage.

In the second operation mode, the negative discharge circuit 320 equalizes the negative control voltages VCOML and VGOFF with the first-level voltage. The negative discharge circuit 320 includes negative dischargers NDISC to which the negative control voltages VCOML and VGOFF are applied.

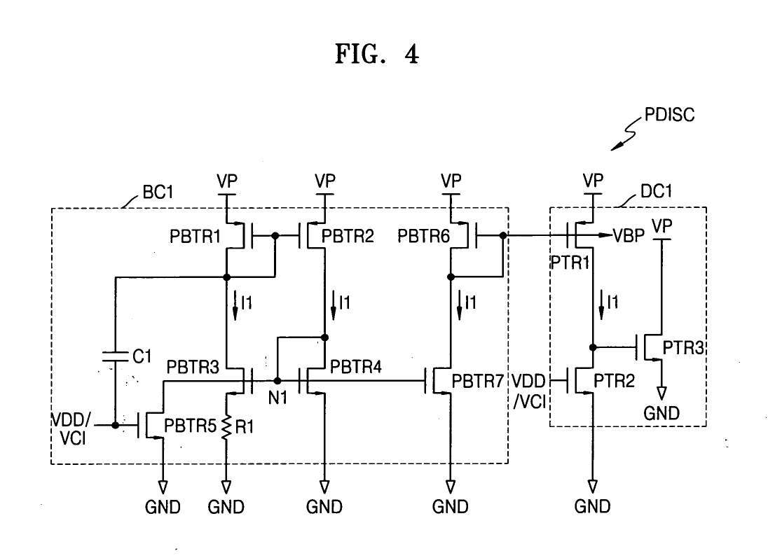

FIG. 4 is a circuit diagram of the positive discharger PDISC of FIG. 3. The positive discharger PDISC of FIG. 3 includes a first bias circuit BC1 and a first controller DC1.

The first bias circuit BC1 is turned off in the first operation mode and generates a first bias current I1 in response to one of the first and second power supply voltages VDD and VCI in the second operation mode.

The first controller DC1 is turned off in the first operation mode, and equalizes the first gate drive voltage VGH, the first source drive voltage AVDD, and the first common voltage VCOMH with the first-level voltage in response to the first bias current I1 in the second operation mode.

The first bias circuit BC1 includes first through seventh positive bias transistors PBTR1 through PBTR7 and a first capacitor C1. The first controller DC1 includes first through third positive transistors PTR1 through PTR3.

A positive control voltage VP is applied to a first terminal of the first positive bias transistor PBTR1 and a gate and second terminal thereof are connected. In FIG. 4, the positive control voltages VP correspond to the first and second source drive voltages AVDD and GVDD, the first common voltage VCOMH, and the first gate drive voltage VGH. Hereinafter, these positive control voltages AVDD, GVDD, VCOMH, and VGH will be referred to as the positive control voltages VP for convenience.

The positive control voltage VP is applied to a first terminal of the second positive bias transistor PBTR2 and its gate is connected to the gate of the first positive bias transistor PBTR1. A first terminal of the third positive bias transistor PBTR3 is connected to the second terminal of the first positive bias transistor PBTR1, its gate is connected to a first node N1, and its second terminal is connected to a ground voltage GND via a first control resistor R1.

A first terminal of the fourth positive bias transistor PBTR4 is connected to the second terminal of the second positive bias transistor PBTR2. The first terminal and gate of the fourth positive bias transistor PBTR4 are connected to the first node N1, and its second terminal is connected to the ground voltage GND.

A first power supply voltage VDD or a second power supply voltage VCI is applied to a gate of the fifth positive bias transistor, and its first and second terminals are connected to the first node N1 and the ground voltage GND, respectively.

A first terminal of the sixth positive bias transistor PBTR6 is connected to the positive control voltage VP and its gate and second terminal are connected. A positive bias voltage VBP is output from the gate thereof. A first terminal of the seventh positive bias transistor PBTR7 is connected to the second terminal of the sixth positive bias transistor PBTR6, and its gate and second terminal are connected to the first node N1 and the ground voltage GND, respectively.

The first capacitor C1 is connected between the second terminal of the first positive bias transistor PBTR1 and the gate of the fifth positive bias transistor PBTR5.

In the first operation mode, the display device 200 is connected to a battery (not shown) and the first and second power supply voltages VDD and VCI are at high levels.

In this case, the fifth positive bias transistor PBTR5 is turned on and a voltage at the first node N1 is equal to the ground voltage GND. Also, a predetermined amount of electric charge is stored in the first capacitor C1, and thus, the third and fourth positive bias transistors PBTR3 and PBTR4 are turned off, thereby preventing the first bias current I1 from flowing through the third and fourth positive bias transistors PBTR3 and PBTR4.

Also, the seventh positive bias transistor PBTR7 is turned off, thereby preventing the first bias current I1 from flowing through the sixth and seventh positive bias transistors PBTR6 and PBTR7.

A first terminal and gate of the first positive transistor PTR1 of the first controller DC1 are connected to the positive control voltage VP and the gate of the sixth positive bias transistor PBTR6, respectively. A first and the second terminal of the second positive transistor PTR2 are connected to the second terminal of the first positive transistor PTR1 and the ground voltage GND, respectively, and the first or second power supply voltage VDD or VCI are applied to its gate of the second positive transistor PTR2.

A first terminal, gate, and second terminal of the third positive transistor PTR3 are connected to the positive control voltage VP, the second terminal of the first positive transistor PTR1, and the ground voltage GND, respectively.

Since both the first and second power supply voltages VDD and VCI are at a high level, the second positive transistor PTR2 is turned on to equalize a voltage at the gate of the third positive transistor PTR3 with the ground voltage GND, thereby turning off the third positive transistor PTR3. As a result, the positive control voltage VP is not changed and is output to the outside of the display device 200.

However, when the battery is unexpectedly removed from the display device 200 and the display device 200 enters the second operation mode, the first and second power supply voltages VDD and VCI are at a low level. Then, the fifth positive bias transistor PBTR5 of the first bias circuit BC1 is turned off and the first capacitor C1 makes voltages at the gates of the first and second positive bias transistors PBTR1 and PBTR2 be at a low level.

Accordingly, the first and second positive bias transistors PBTR1 and PBTR2 are turned on and the first bias current I1 flows through the first and second positive bias transistors PBTR1 and PBTR2. The amount of the first bias current I1 is determined by the sizes of the third and fourth positive bias transistors PBTR3 and PBTR4 and the first control resistor R1.

The first bias current I1 allows a voltage at the first node N1 to be at a high level, and the sixth and seventh positive bias transistors PBTR6 and PBTR7 to be turned on.

In this case, the first positive transistor PTR1 is turned on, and the second positive transistor PTR2 is also turned on by the first or second power supply voltage VDD or VCI. The first bias current I1 flowing between the first and second positive transistors PTR1 and PTR2 turns on the third positive transistor PTR3, and the positive control voltage VP is lowered to the ground voltage GND and output to the outside of the display device 200.

When the positive discharger PDISC of FIG. 4 makes the display device 200 enter the second operation mode, the positive control voltage VP that controls the operations of the panel 210, the source driver 260, and the gate driver 250 is lowered to the ground voltage GND.

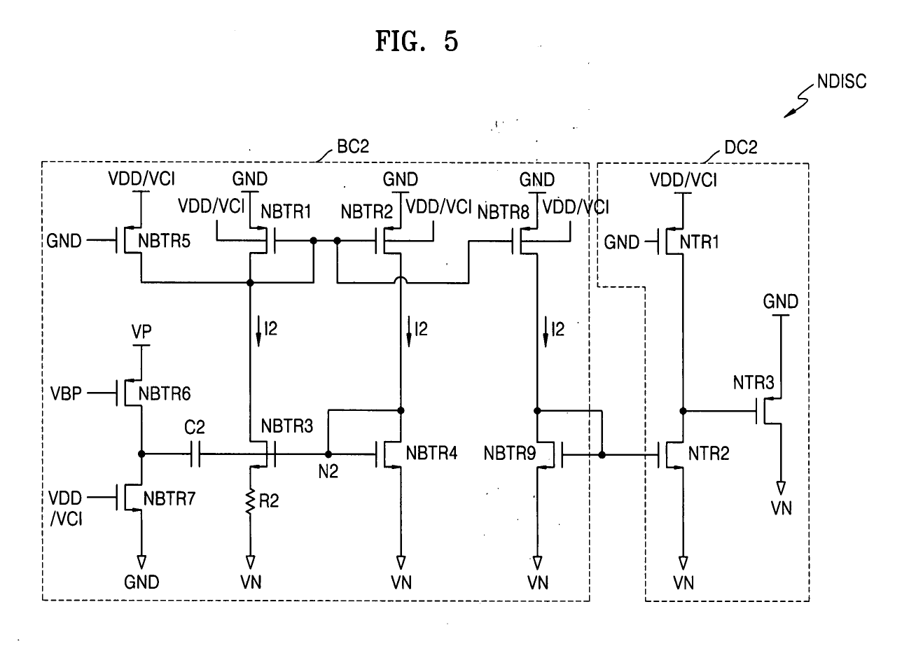

FIG. 5 is a circuit diagram of the negative discharger NDISC of FIG. 3. Referring to FIG. 5, the negative discharger NDISC includes a second bias circuit BC2 and a second controller DC2.

The second bias circuit BC2 is turned off in the first operation mode, and generates a second bias current I2 in response to the first or second power supply voltage VDD or VCI in the second operation mode.

The second controller DC2 is turned off in the first operation mode, and equalizes the second gate drive voltage VGOFF and the second common voltage VCOML with the first-level voltage in response to the second bias current I2 in the second operation mode.

The second bias circuit BC2 includes first through ninth negative bias transistors NBTR1 through NBTR1 and a second capacitor C2. The second controller DC2 includes first through third negative transistors NTR1, NTR2, and NTR3.

A first terminal of the first negative bias transistor NBTR1 of the second bias circuit BC2 is connected to the ground voltage GND and its gate and second terminal are connected. A first terminal and gate of the second negative bias transistor NBTR2 are connected to the ground voltage GND and the gate of the first negative bias transistor NBTR1, respectively.

A first terminal and gate of the third negative bias transistor NBTR3 are connected to the second terminal of the first negative bias transistor NBTR1 and a second node N2, respectively, and its second terminal is connected to a negative control voltage VN via a second control resistor R2. The negative control voltages VN include the second common voltage VCOML and the second gate drive voltage VGOFF that have negative voltage levels. Hereinafter, the second common voltage VCOML and the second gate drive voltage VGOFF will be referred to as the negative control voltages VN for convenience.

A first terminal of the fourth negative bias transistor NBTR4 is connected to the second terminal of the second negative bias transistor NBTR2, its first terminal and gate are connected to the second node N2, and its second terminal thereof is connected to the negative control voltage VN.

A first terminal of the fifth negative bias transistor NBTR5 is connected to the first power supply voltage VDD or the second power supply voltage VCI, its gate is connected to the ground voltage GND, and its second terminal is connected to the second terminal of the first negative bias transistor NBTR1.

A first terminal of the sixth negative bias transistor NBTR6 is connected to the positive control voltage VP and a positive bias voltage VBP is applied to its gate. A first terminal of the seventh negative bias transistor NBTR7 is connected to the second terminal of the sixth negative bias transistor NBTR6, a first power supply voltage VDD or the second power supply voltage VCI are applied to its gate, and its second terminal is connected to the ground voltage GND.

The second capacitor C2 is connected between the second terminal of the sixth negative bias transistor NBTR6 and the second node N2. A first terminal and gate of the eighth negative bias transistor NBTR8 are connected to the ground voltage GND and the gate of the second negative bias transistor NBTR2, respectively.

A first terminal and gate of the ninth negative bias transistor NBTR9 are connected to the second terminal of the eighth negative bias transistor NBTR8, and its second terminal is connected to the negative control voltage VN. The first or second power supply voltage VDD or VCI is applied to the bulks of the first, second, and eighth negative bias transistors NBTR1, NBTR2, and NBTR8.

When the display device 200 does not operate in the first operation mode, the positive bias voltage VBP is maintained at a high level and the sixth negative bias transistor NBTR6 is turned off.

The seventh negative bias transistor NBTR7 is turned on by the first or second power supply voltage VDD or VCI and the second capacitor C2 makes a voltage at the second node N2 be at a low level. In this case, the third and fourth negative bias transistors NBTR3 and NBTR5 are turned off and the second bias current I2 does not flow through the third and fourth negative bias transistors NBTR3 and NBTR5.

Also, in this case, the fifth negative bias transistor NBTR5 is turned on and the first and second negative bias transistor NBTR1 and NBTR2 are turned off by the first or second power supply voltage VDD or VCI.

The eighth negative bias transistor NBTR8 is also turned off by the first or second power supply voltage VDD or VCI. Accordingly, the second bias current I2 does not flow between the eighth and ninth negative bias transistors NBTR8 and NBTR9.

A first terminal of the negative transistor NTR1 is connected to the first or second power supply voltage VDD or VCI and its gate is connected to the ground voltage GND. A first terminal, gate, and second terminal of the second negative transistor NTR2 are connected to the second terminal of the first negative transistor NTR1, the gate of the ninth negative bias transistor NBTR9, and the negative control voltage VN, respectively.

A first terminal, gate, and second terminal of the third negative transistor NTR3 are connected to the ground voltage GND, the second terminal of the first negative transistor NTR1, and the negative control voltage VN, respectively.

Although the second negative transistor is turned off, the first negative transistor NTR1 is turned on by the ground voltage GND connected to the gate of the first negative transistor NTR1, and therefore, the third negative transistor NTR3 is turned off by the first or second power supply voltage VDD or VCI applied to the gate of the third negative transistor NTR3. Thus, the negative control voltage VN is not changed and is output to the outside of the display device 200.

However, when the battery is unexpectedly removed from the display device 200 and the display device enters the second operation mode, the first and second power supply voltages VDD and VCI become a low level. In this case, the seventh negative bias transistor NBTR7 is turned off and the positive bias voltage VBP is at a low level in the second operation mode. Accordingly, the sixth negative bias transistor NBTR6 is turned on.

When the sixth negative bias transistor NBTR6 is turned on, a voltage at its second terminal is increased. Also, a voltage at the second node N2 is increased by the second capacitor C2. As a result, the third and fourth negative bias transistors NBTR3 and NBTR4 are turned on.

The first or second power supply voltage VDD or VCI applied to the first terminal of the fifth negative bias transistor NBTR5 is also at a low level, and thus, the fifth negative bias transistor NBTR5 is turned off and the first and second negative bias transistors NBTR1 and NBTR2 are turned on by the turned-on third and fourth negative bias transistors NBTR3 and NBTR4.

Thus, the second bias current I2 flows through between the first and second negative bias transistors NBTR1 and NBTR2. The amount of the second bias current I2 is determined by the sizes of the third and fourth negative bias transistors NBTR3 and NBTR4 and the second control resistor R2.

Since voltages at the gates of the first and second negative bias transistors NBTR1 and NBTR2 are at a low level, the eighth negative bias transistor NBTR8 is turned on and the ninth negative bias transistor NBTR9 is turned on by the second bias current I2 flowing through the eighth and ninth negative bias transistors NBTR8 and NBTR9.

Thus, since the second negative transistor NTR2 is turned on and the first negative transistor NTR1 is turned off, a voltage at the gate of the third negative transistor NTR3 becomes the negative control voltage VN, thereby turning on the third negative transistor NTR3.

When the third negative transistor NTR3 is turned on, the negative control voltage VN is increased to the ground voltage GND. That is, the negative control voltage VN is increased to the ground voltage GND and discharged to the exterior of the display device 200. When the negative dischargers NDISC allow the display device 200 to enter the second operation mode, the negative control voltage VN that controls the operations of the panel 210, the source driver 260, and the gate driver 250 is increased to the ground voltage GND.

Removal of the battery from the display device 200 makes the voltage level controller 245 change the control voltages AVDD, GVDD, VCOMH, VCOML, VGH, and VGOFF to the ground voltage GND. Then, the gate driver 250 equalizes voltages at all the gate lines of the panel 210 with the ground voltage GND and the source driver 260 equalizes voltages at all the source lines with the ground voltage GND.

When the voltages at all the gate lines become the ground voltage GND, the gate lines are slightly turned on. Also, a voltage at the common voltage terminal VCOM connected to the capacitors CST storing the color data DATA becomes the ground voltage GND and the voltages at the source lines become the ground voltage GND. Accordingly, the color data DATA stored in the capacitors CST is discharged via transistors TFT connected to the gate lines.

According to at least one embodiment of the present invention, a latent image is removed by deliberately discharging the electric charges stored in the capacitors CST when the battery is removed from the display device 200 more quickly than when the latent image is naturally discharged.

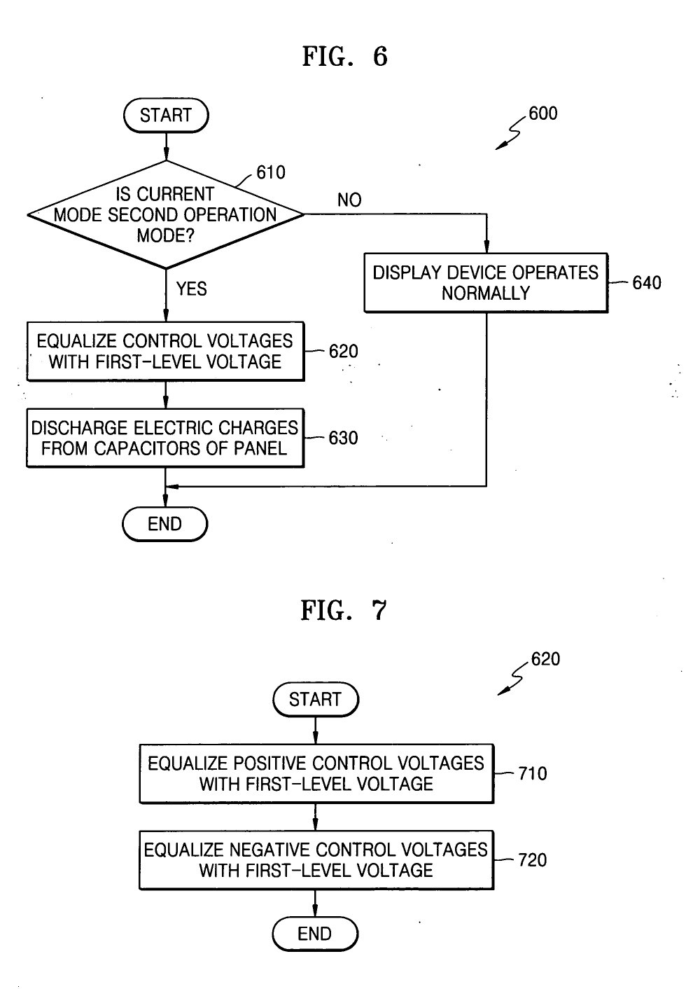

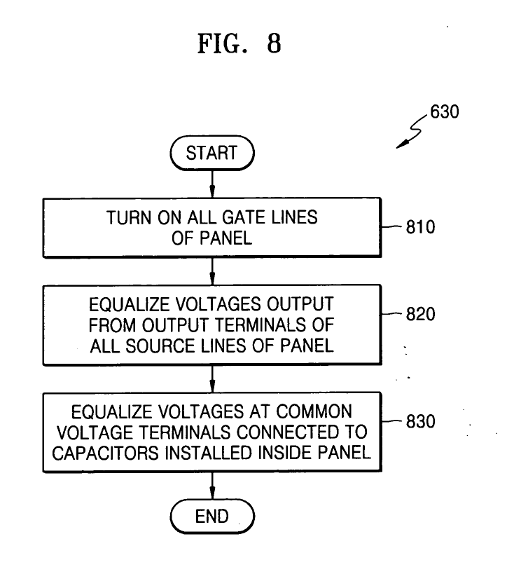

FIG. 6 is a flowchart of a method 600 of removing a latent image from a panel according to an embodiment of the present invention. FIG. 7 is a detailed flowchart of operation 620 of FIG. 6. FIG. 8 is a detailed flowchart of operation 630 of FIG. 6.

In the method 600, a latent image is removed from a panel when a battery is removed from a display device with a driver unit that displays an image on a panel using control voltages.

The method 600 will now be described in detail with reference to FIGS. 2 through 6. First, it is determined whether the display device 200 enters a first operation mode or a second operation mode (operation 610). The first operation mode indicates where the display device 200 can operate normally, and the second operation mode indicates where a battery (not shown) is removed from the display device 200.

If it is determined that the display device enters the first operation mode, the display device 200 reproduces an image (operation 640) normally. If it is determined that the display device enters the second operation mode, the display device 200 equalizes the control voltages AVDD, GVDD, VCOMH, VCOML, VGH, and VGOFF with a first-level voltage (operation 620).

In this embodiment, the first-level voltage is the ground voltage GND. The control voltages AVDD, GVDD, VCOMH, VCOML, VGH, and VGOFF allow the display device 200 to be driven as described above, and their descriptions will be omitted.

After operation 620, electric charges in the capacitors CST of the panel 210 are discharged in response to the control voltages AVDD, GVDD, VCOMH, VCOML, VGH, and VGOFF (operation 630). Since the electric charges in the capacitors CST are deliberately discharged, the latent image can be rapidly removed from the panel 210.

More specifically, in operation 620, the positive control voltages AVDD, GVDD, VCOMH, and VGH of the control voltages AVDD, GVDD, VCOMH, VCOML, VGH, and VGOFF are equalized with the first-level voltage, i.e., the ground voltage GND (operation 710). Next, the negative control voltages VCOML and VGOFF of the control voltages AVDD, GVDD, VCOMH, VCOML, VGH, and VGOFF are equalized with the first-level voltage (operation 720).

Operation 720 is performed by the positive dischargers PDISC and the negative dischargers NDISC of FIGS. 4 and 5.

More specifically, in operation 630, all the gate lines of the panel 210 are turned on in response to parts of the control voltages AVDD, GVDD, VCOMH, VCOML, VGH, and VGOFF (operation 810).

Next, the voltages at the source lines of the panel 210 are equalized with the first-level voltage in response to parts of the control voltages AVDD, GVDD, VCOMH, VCOML, VGH, and VGOFF (operation 820). Lastly, voltages at the common voltage terminals VCOM connected to the capacitors CST inside the panel 210 are equalized with the first-level voltage in response to parts of the control voltages AVDD, GVDD, VCOMH, VCOML, VGH, and VGOFF (operation 830).

According to this embodiment of the invention, the voltages at the gate lines that control the operation of a panel are equalized with a ground voltage so as to turn on the transistors, the voltages at the common voltage terminals connected to the capacitors are equalized with a ground voltage so as to discharge the capacitors, and the voltages at the output terminals of the source lines of the panel are also equalized with the ground voltage. Accordingly, the capacitors are discharged, thereby immediately removing a latent image from the panel.

While this invention has been particularly shown and described with reference to exemplary embodiments thereof, it will be understood by those skilled in the art that various changes in form and details may be made therein without departing from the spirit and scope of the invention as defined by the appended claims.

1. A display device comprising:
a panel; and
a driver unit displaying an image on the panel,
wherein the driver unit comprises:
a controller generating a control signal and color data in response to a first power supply voltage;
a voltage generator generating control voltages in response to the control signal and a second power supply voltage;
a voltage level controller receiving the control voltages, outputting the control voltages in a first operation mode, and outputting the control voltages as first-level voltages in a second operation mode; and
a source driver and a gate driver controlling source lines and gate lines of the panel, respectively, in response to the color data, the control signal, and the control voltages.

2. The display device of claim 1, wherein the gate driver equalizes voltages at all the gate lines of the panel with the first-level voltage in response to parts of the control voltages in the second operation mode, and
the source driver equalizes voltages output from output terminals of all the source lines of the panel with the first-level voltage in response to other parts of the control voltages in the second operation mode.

3. The display device of claim 1, wherein the first operation mode indicates where the display device normally operates, and
the second operation mode indicates where a battery is removed from the display device.

4. The display device of claim 3, wherein the first and second power supply voltages are output from the battery,
the first and second power supply voltages are equalized with a ground voltage in the second operation mode, and
the second power supply voltage is larger than the first power supply voltage.

5. The display device of claim 1, wherein the control voltages comprise a first gate drive voltage and a second gate drive voltage applied to the gate driver, a first source drive voltage and a second source drive voltage applied to the source driver, and a first common voltage and a second common voltage applied to the panel.

6. The display device of claim 5, wherein the voltage level controller comprises:
a positive discharge circuit equalizing positive control voltages of the control voltages that have positive voltage levels with the first-level voltage in the second operation mode; and
a negative discharge circuit equalizing negative control voltages of the control voltages that have negative voltage levels with the first-level voltage in the second operation mode.

7. The display device of claim 6, wherein the positive discharge circuit comprises positive dischargers connected to the positive control voltages, respectively,
wherein each of the positive dischargers comprises:
a first bias circuit being turned off in the first operation mode, and generating a first bias current in response to one of the first and second power supply voltages in the second operation mode; and
a first controller being turned off in the first operation mode, and equalizing the first gate drive voltage, the first source drive voltage, and the first common voltage with the first-level voltage in response to the first bias current in the second operation mode.

8. The display device of claim 7, wherein the first bias circuit comprises:
a plurality of positive bias transistors, each positive bias transistor having a first terminal, a second terminal and a gate;
a first positive bias transistor whose first terminal is connected to the positive control voltage and whose gate and second terminal are connected;
a second positive bias transistor whose first terminal is connected to the positive control voltage and whose gate is connected to the gate of the first positive bias transistor;
a third positive bias transistor whose first terminal is connected to the second terminal of the first positive bias transistor, whose gate is connected to a first node, and whose second terminal is connected to a ground voltage via a first control resistor;
a fourth positive bias transistor whose first terminal is connected to the second terminal of the second positive bias transistor, whose first terminal and gate are connected to the first node, and whose second terminal is connected to the ground voltage;
a fifth positive bias transistor whose gate receives one of the first and second power supply voltages, whose first terminal is connected to the first node, and whose second terminal is connected to the ground voltage;
a first capacitor connected between the second terminal of the first positive bias transistor and the gate of the fifth positive bias transistor;
a sixth positive bias transistor whose first terminal is connected to the positive control voltage and whose gate and second terminal are connected; and
a seventh positive bias transistor whose first terminal is connected to the second terminal of the sixth positive bias transistor, whose gate is connected to the first node, and whose second terminal is connected to the ground voltage.

9. The display device of claim 8, wherein a positive bias voltage is output from the gate of the sixth positive bias transistor of the first bias circuit.

10. The display device of claim 7, wherein the first controller comprises:
a plurality of positive transistors, each positive transistor having a first terminal, a second terminal and a gate;
a first positive transistor whose first terminal is connected to the positive control voltage and whose gate is connected to the gate of the sixth positive bias transistor;
a second positive transistor whose first terminal is connected to the second terminal of the first positive transistor, whose gate receiving one of the first and second power supply voltages, and whose second terminal is connected to the ground voltage; and
a third positive transistor whose first terminal is connected to the positive control voltage, whose gate is connected to the second terminal of the first positive transistor, and whose second terminal is connected to the ground voltage;

11. The display device of claim 6, wherein the negative discharge circuit comprises negative dischargers connected to the negative control voltages, respectively,
wherein each of the negative dischargers comprises:
a second bias circuit being turned off in the first operation mode, and generating a second bias current in response to one of the first and second power supply voltages in the second operation mode; and
a second controller being turned off in the first operation mode, and equalizing the second gate drive voltage, the second source drive voltage, and the second common voltage with the first-level voltage in response to the second bias current in the second operation mode.

12. The display device of claim 11, wherein the second bias circuit comprises:
a plurality of negative bias transistors, each negative bias transistor having a first terminal, a second terminal and a gate;
a first negative bias transistor whose first terminal is connected to the ground voltage and whose gate and second terminal are connected;
a second negative bias transistor whose first terminal is connected to the ground voltage and whose gate is connected to the gate of the first negative bias transistor;
a third negative bias transistor whose first terminal is connected to the second terminal of the first negative bias transistor, whose gate is connected to a second node, and whose second terminal is connected to the negative control voltage via a second control resistor;
a fourth negative bias transistor whose first terminal is connected to the second terminal of the second negative bias transistor, whose first terminal and gate are connected to the second node, and whose second terminal is connected to the negative control voltage;
a fifth negative bias transistor whose first terminal is connected to one of the first and second power supply voltages, whose gate is connected to the ground voltage, and whose second terminal is connected to the second terminal of the first negative bias transistor;
a sixth negative bias transistor whose first terminal is connected to the positive control voltage, and a positive bias voltage is applied to its gate;
a seventh negative bias transistor whose first terminal is connected to the second terminal of the sixth negative bias transistor, whose gate receives one of the first and second power supply voltages, and whose second terminal is connected to the ground voltage;
a second capacitor connected between the second terminal of the sixth negative bias transistor and the second node;
an eighth negative bias transistor whose first terminal is connected to the ground voltage and whose gate is connected to the gate of the second negative bias transistor; and
a ninth negative bias transistor whose first terminal is connected to the second terminal of the eighth negative bias transistor, whose gate is connected to the first terminal of the ninth negative bias transistor, and whose second terminal is connected to the negative control voltage,
wherein one of the first and second power supply voltages is applied to bulks of the first, second, and eighth bias transistors.

13. The display device of claim 11, wherein the second controller comprises:
a plurality of negative transistors, each negative transistor having a first terminal, a second terminal and a gate;
a first negative transistor whose first terminal is connected to one of the first and second power supply voltages and whose gate is connected to the ground voltage;
a second negative transistor whose first terminal is connected to the second terminal of the first negative transistor, whose gate is connected to the gate of the ninth negative bias transistor, and whose second terminal is connected to the positive control voltage; and
a third negative transistor whose first terminal is connected to the ground voltage, whose gate is connected to the second terminal of the first negative transistor, and whose second terminal is connected to the positive control voltage.

14. The display device of claim 1, wherein the panel is an active matrix type panel.

15. The display device of claim 1, wherein the first-level voltage is the ground voltage.

16. A method of removing a latent image from a panel when power is lost from a display device with a driver unit that displays an image on the panel using control voltages, the method comprising:
determining whether a current mode is a first operation mode or a second operation mode;
equalizing the control voltages with a first-level voltage in the second operation mode; and
discharging electric charges in the panel in response to the control voltages that have become equal to the first-level voltages.

17. The method of claim 16, wherein equalizing the control voltages with the first-level voltage comprises:
equalizing positive control voltages of the control voltages that have positive voltage levels with the first-level voltage; and
equalizing negative control voltages of the control voltages that have negative voltage levels with the first-level voltage.

18. The method of claim 16, wherein the first operation mode indicates that the display device operates normally, and the second operation mode indicates that the battery is removed from the display device.

19. The method of claim 16, wherein the discharging of electric charges comprises:
turning on all gate lines of the panel in response to parts of the control voltages;
equalizing voltages output from output terminals of all source lines of the panel with the first-level voltage in response to other parts of the control voltages; and
equalizing voltages at common voltage terminals connected to capacitors installed in the panel with the first-level voltage in response to other parts of the control voltages.

20. The method of claim 19, wherein the first-level voltage is a ground voltage.

21. The method of claim 16, further comprising operating the display device normally when the current mode is determined to be the first operation mode.

22. A display device comprising:
a panel; and
a driver unit displaying an image on the panel,
wherein the driver unit comprises:
means for detecting a condition occurring when power is lost to the panel or when a battery is removed from the panel; and means for removing the image from the panel upon occurrence of the condition.
